(19) United States
(12) Patent Application Publication
(10) Pub. No.: US 2016/0165947 A1
(43) Pub. Date: Jun. 16, 2016

(54) Fruit and Vegetable Washer

(71) Applicant: Mary Ellen Hoye, Homer Glen, IL (US)

(72) Inventor: Mary Ellen Hoye, Homer Glen, IL (US)

(21) Appl. No.: 14/567,129

(22) Filed: Dec. 11, 2014

(51) Int. Cl. A23N 12/06

(52) U.S. Cl. CPC A23N 12/06

(57) ABSTRACT

A fruit and vegetable washer that can contain a washer similar to a dishwasher spray, a dispenser and reservoir to hold a several cups of cleaning fluid to dispense the appropriate amount necessary depending on the selection of the type of product being cleaned, a vibrator or agitator, a fan and water rinse. The invention draws the cleansing liquid up into spray jets, and depending the type of fruit being cleaned, sprays with different forces. Then, water can spray through the same jets and soak the fruit. During the soak cycle, depending on the type of product a mechanical device can vibrate/agitate the soak compartment. After the soak cycle is complete the water is drained, and a fan can dry the cleansed food. The unit can have an optional refrigerator to maintain fruit and vegetables at near the optimum storage temperature of 40 degrees F.

### BACKGROUND

1. Field of the Invention

The present invention relates generally to kitchen appliances and more particularly to a fruit and vegetable washer that cleans fruits and vegetables and holds them at an optimum storage temperature.

2. Description of the Prior Art

It is well-known the most fruits and vegetables are subjected to numerous contaminants including pesticides, dirt, soil and animal wastes. The washing of fruits and vegetables not only helps remove dirt, bacteria, and stubborn garden pests, but it also helps remove residual pesticides.

To make fruits and vegetables totally safe to eat, they need to be thoroughly washed with at least water and better with vinegar or a cleansing product designed for the job. Prior art systems mostly require hand-washing. This is usually inadequate for total safety. Also, some products are more delicate that others. For example, it is possible to vigorously wash grapes, while strawberries must be handled gently. It would be tremendously advantageous to have an automatic fruit and vegetable washer unit that can adjust its washing process to the type of product being washed, and can then dry the fruit or vegetable. It would also be advantageous for the device to be able to store the washed product at an optimum temperature of around 40 to 50 degrees F. The water used to wash should be no more than 10 degrees colder than then produce to prevent the entrance of microorganisms into the stem or blossom end of the produce, assuming the product is already in the refrigerator.

### SUMMARY OF THE INVENTION

The present invention relates to a fruit and vegetable washer device that can be supplied in various sizes. A small unit can be the size of a coffee maker, while a larger family or commercial unit can be the size of a dishwasher or any size in between. One embodiment is a mid-sized unit plumbed under a sink about the width of one standard cabinet door. Thus, the size of the unit may vary from the small portable countertop to that which may fit under most kitchen sinks for easy plumbing and storage or as a plumbed coffee maker be attractively designed similar to a dishwasher and be placed on the counter near the sink and outlet.

The device can contain a refrigerator unit, a washer similar to a dishwasher spray, a dispenser and reservoir to hold a several cups of white vinegar or similar cleaning fluid to dispense the appropriate amount necessary depending on the selection of the type of product being cleaned, a vibrator or agitator, a fan and water rinse. There can be a filter at the bottom of each chamber to collect larger particles to not clog drains.

The device can include two liquid decanters, one of which holds the cleansing liquid (fruit wash, vinegar and water) and the other holds water, or the water can be permanently plumbed. The machine typically draws the cleansing liquid up into spray jets, and depending the type of fruit being cleaned, sprays with different forces. For example for strawberries, there will be a be a lighter force used coming from the jets than for grapes. After the cleaning liquid, water can spray through the same jets but in much greater quantity to fill the compartment and soak the fruit. During the soak cycle, depending on the type of product a mechanical device can vibrate/agitate the soak compartment. This step can be adjusted to the product. For example, it may be desirable to soak and agitate mushrooms, but not raspberries. After the soak cycle is complete the water is drained, and a fan can dry the cleansed food. In addition, an optional spin cycle can further dry the product. The unit can be self-contained, or can be designed to attached temporarily to any sink and drain into a sink.

The unit can have an optional refrigerator to maintain fruit and vegetables at near the optimum storage temperature of 40 degrees F.

### DESCRIPTION OF THE FIGURES

Attention is now directed at several figures that illustrate features of the present invention:

FIG. 1A shows a front view of an embodiment of the present invention with doors closed.

FIG. 1B shows the embodiment of FIG. 1A with the doors removed.

FIG. 2A shows the back of the embodiment of FIGS. 1A-1B

FIG. 2B shows the top of the embodiment.

FIG. 3 shows a side view of the embodiment.

FIG. 4 is a schematic drawing of typical components that can be used with embodiments of the present invention.

FIG. 5 shows a block diagram of a controllers used to control the invention.

Several drawings and illustrations have been presented to aid in understanding the present invention. The scope of the present invention is not limited to what is shown in the figures.

### DESCRIPTION OF THE PREFERRED EMBODIMENTS

The present invention relates to a fruit and vegetable washer that can be supplied in different sizes. The device can include a liquid decanter to hold the cleansing liquid (fruit wash, vinegar and water) and a water supply that can be permanently plumbed or be a second decanter. The machine draws the cleansing liquid up into spray jets, and depending the type of fruit being cleaned, sprays with different forces. After the cleaning liquid, water can spray through the same jets but in much greater quantity to fill the compartment and soak the fruit. During the soak cycle, depending on the type of product a mechanical device can vibrate/agitate the soak compartment. This step can be adjusted to the product. After the soak cycle is complete, the water is drained, and a fan can dry the cleansed food and/or an optional spin cycle can further dry the product. The device can also include a refrigerator to maintain an optimum storage temperature so that cleaned product can be stored for use. The optimum storage temperature is typically between 40 and 50 degrees F. The refrigerator may optionally have an adjustable temperature selection.

The invention is typically controlled by a controller that can select different spray strengths and cycles for different products. The controller can be set up to choose cycles for different products using a display and/or buttons. The invention can include multiple trays (tray/bowls that have sides and slots for drainage) fruit and vegetable holders, or for larger items the upper ones can be removed to allow space for larger foods on the bottom. At the very top of the larger unit there can be a smaller pull out drawer or tray to hold a lesser amount or smaller foods (more of a single serving or multiple single servings). Water and vinegar (or non-clogging cleaning agent of choice) can fill the chamber(s) selected by spraying the food. Once the chamber is full, there can be a back and forth rotation of the bowl-tray along with a gentle vibration to shake free lodged particles. A total time in water varies depending on the selection which should vary depending on the food being cleaned. Strawberries for example should be in soaking solution no more than 2 minutes. The solution is then drained, and the chamber refills with clean cold water by again a spray from various angles above and below the tray/bowl (forced dependent on selection). Once the chamber is full, the device can supply vibration and/or agitation (back and forth movement like a clothes washer), and then after a predetermined time, be drained and dried either with a fan or by spinning to dry the bulk of the water from the product. The spin feature is optional, and in some embodiments, different spin speeds can be selected or commanded. The fan can run for approximately 2-10 minutes again depending on selection. The chamber door can seal closed and lock during the washing and rinsing cycle, and can have an optional a window. As previously stated, the size of the unit may vary from the small portable countertop unit to a dishwasher size unit which may fit under most kitchen sinks for easy plumbing.

Foods may be cleaned in the morning for dinner use and left there because the present invention doubles as a refrigerator. In this way, there is no rush to move products until ready for use. In fact, the unit can be filled at any time with what might be used for several days to one week having it washed and ready to consume at any time.

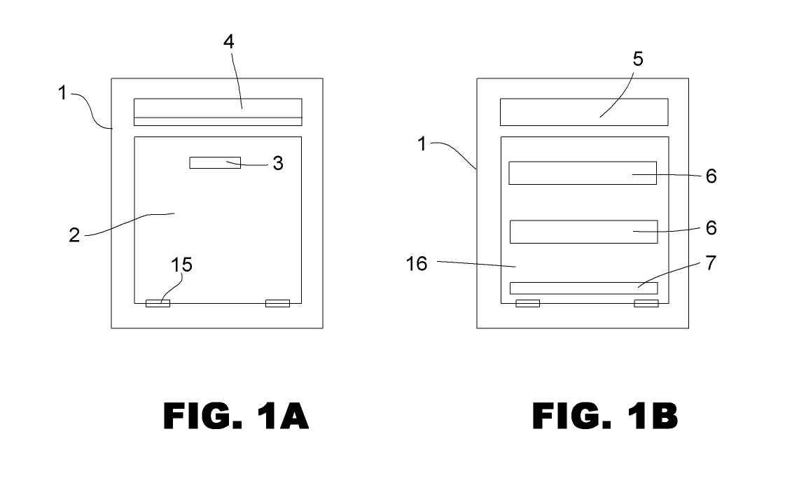

FIGS. 1A-1B shows front views of an embodiment of the present invention. FIG. 1A is shown with doors; FIG. 1b is shown without doors. The unit shown is around the size of a coffee-maker; however, as previously stated may be supplied in different sizes. The unit has an outer housing 1 with a door 2 that may have a handle 3. The door 2 opens into a wash compartment 16. There may also be an optional drawer 4 for smaller portions. The door can be hinged 15 or otherwise attached. FIG. 1B shows that inside the upper drawer 4, there is room for a removable tray 5. Lower in the unit, there is room for room for more drawers or for a larger bowl or product holder 6. The bottom can contain a slotted tray or bowl 7. The exact configuration of trays and spaces for bowls and the like can vary with the size of the unit.

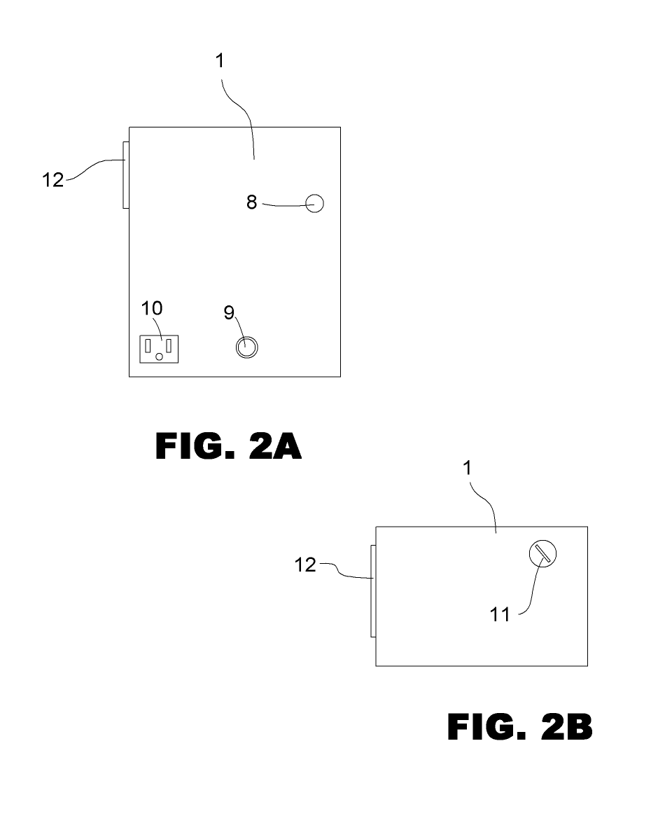

FIG. 2A shows the back of the embodiment of FIGS. 1A-1B. The back is typically flat with a fresh water connection 8 and a drain 9. The fresh water plumbing is optional. Fresh water can be supplied in a canister in smaller units. The drain 9 can be run into a sink on smaller units and can be permanently piped to a sink drain or sewer in the case of larger units. The drain system can be equipped with a filter to trap larger particles such as sand and the like. There is also a 110 volt power plug 10 that can be attached to a power cord. While line power is preferred, it is also possible to power the unit with a lower voltage transformer or with batteries. The edge of a display panel 12 can also be seen in FIG. 2A.

FIG. 2B shows the top of the embodiment. The edge of the display panel 12 can also be seen in this figure. The main feature of the top of the unit is a cap 11 for cleanser. A typical cleanser is white vinegar; however, commercially available fruit wash fluids may also be used. The main purpose of the cleanser is to kill bacteria that might be on any residue on the product. White vinegar is ideal.

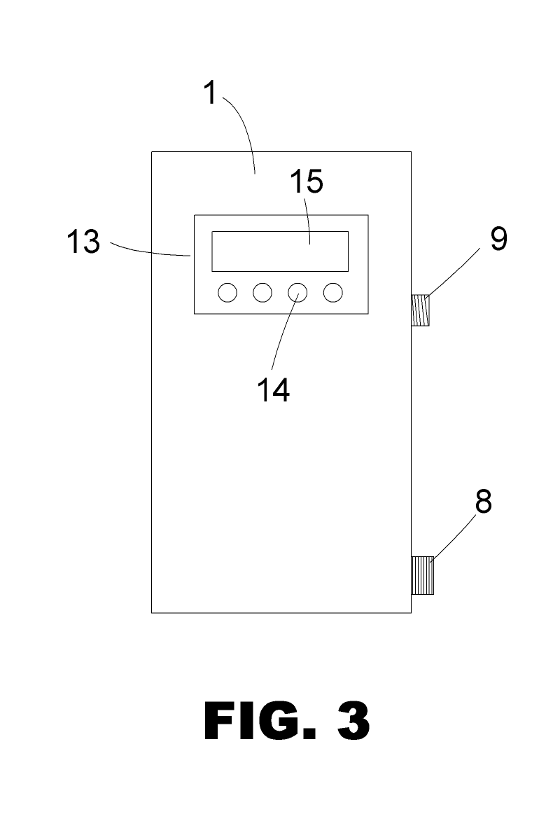

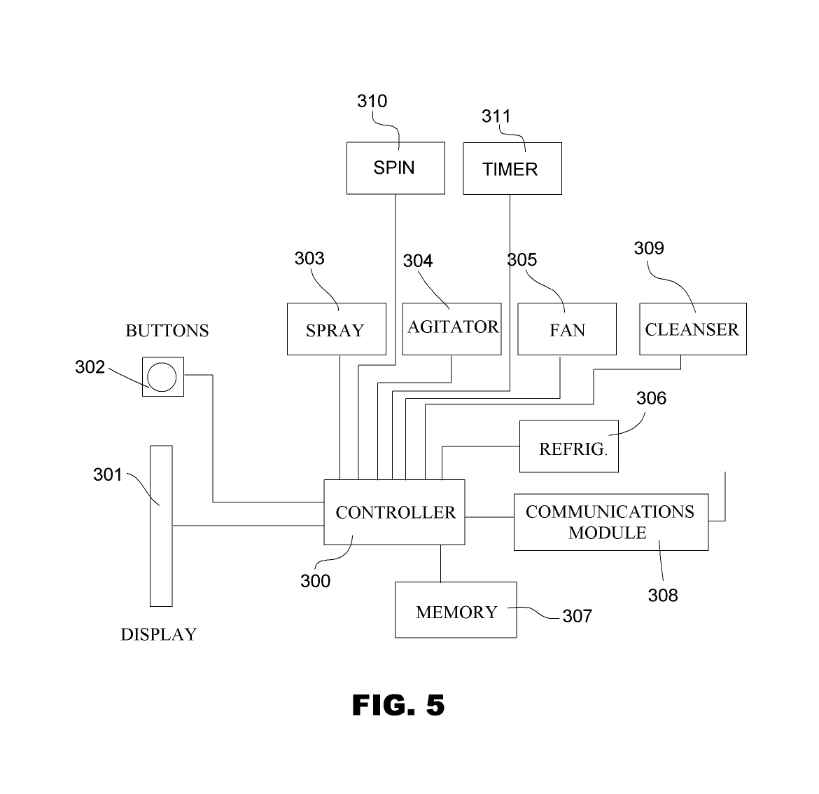

FIG. 3 shows a side view of one side of the device. The fresh water plumbing attachment 8 and the drain 9 can be seen. The main feature of the side of the unit is a control panel 13. A typical control panel may contain a display 15 and several buttons 14. The display 15 is optional, and the entire system can be controlled by buttons. The purpose of the control panel 13 is to allow the user to specify the product being washed. An internal controller (shown in FIG. 5) can be programmed to perform different wash and rinse cycles based on the product. The washing process can range from very gentle to aggressive. The display 15 can show the type of product selected as well as the current step being performed and the time remaining. The entire control panel can be eliminated on small units with buttons simply choosing between gentle, moderate and aggressive or the like. In some embodiments, there can be special buttons for common fruits or vegetables. For example, apples, grapes, berries, etc.

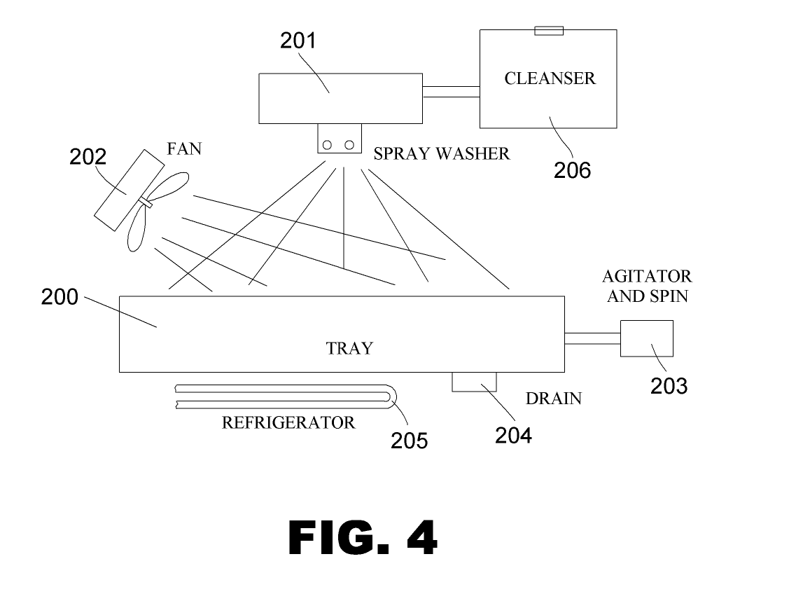

FIG. 4 is a schematic drawing of the washing mechanism. The product to be washed is placed on a tray 200. The tray can be located in a wash compartment in the housing 1. Above the tray is a spray wash head 201 with a system of jets that can spray at different angles. The spray wash 201 can optionally rotate (like the spray in a dishwasher). The spray wash 201, under control of a programmed controller (shown in FIG. 5) to spray the product with cleanser from a canister 206, or to spray with fresh water. Different spray pressures and intensities can be chosen by the controller based on the product chosen to be washed. A vibrator or agitator 203 can move the tray during wash and rinse to dislodge any particles. After the final rinse is drained (some out of a tray drain 204), a fan 202 can be used to blow-dry the product. In addition, the tray can optionally be made to rotate to spin-dry the product. The device can be optionally equipped with refrigeration coils 205 to maintain an optimum storage temperature of around 40 degrees F. using a temperature sensor and a closed-loop thermostat (such as any refrigerator).

FIG. 5 shows a block diagram of the control circuitry used in a preferred embodiment of the invention. A controller 300 is the brain of the unit and controls all selections, processes and sprays. It can be mounted in the housing outside the wash compartment. The controller 300 can be any type of processor including controllers like those manufactured by various semi-conductor manufacturers. The controller can also be a micro-processor or any other type of computer or processor including an external PC, tablet or handheld telephone. The controller 300 can contain internal random access memory (RAM) and read only memory (ROM) as well as programmable flash memory or the like. In addition, the controller 300 can communicate with external memory 307 of any type including ROM, RAM and Flash.

The controller 300 communicates electrically with unit drivers that control local actions. The spray unit has a driver 303 that can adjust spray pressure, spray angle and rotation. The vibrator/agitator controller 304 can be commanded by the controller 300 to agitate or vibrate at different rates and amplitudes. The fan controller 305 can typically be commanded to turn the fan on and off and to control the fan speed. Smaller units may use a fixed fan speed. The cleanser canister control 309 can be commanded to dispense cleanser into the spray unit. A spin control unit 310 can be commanded to cause the tray or other product holder to spin-dry. A timer 311 can be used to time any type of cycle or operation such as spraying, soaking or drying. The timer 311 can optionally be internal to the controller 300. A refrigerator control unit 306 can maintain an optimum temperature for storage and can be turned on and off, either automatically, or by user command.

FIG. 5 also shows the controller 300 electrically connected with a communications module 308. The communications module 308 is optional and may communicate with a network using WiFi or for close range BLUETOOTH™ or by the cellular telephone network. In this mode, the entire washing process may remotely commanded and/or controlled over a network. In addition, a smartphone with a loaded application (App) can control the washer unit including product selection and starting the process.

While the use of a controller is the preferred method of practicing the invention, various embodiments may also be hand-adjustable allowing adjustment of different spray forces, clean and soak times, and drying times. Also, while a semi-conductor controller known in the art is preferred, the controller may be mechanical, analog electrical, relay logic or simply hardwired. Permanent plumbing is preferred; however, any number of canisters may be used to hold cleanser and rinse liquids. Canisters may be combined with hard pipe plumbing. Any number of trays or separate compartments may be supplied with different embodiments of the invention. While the preferred method is to spray from the top at different forces and angles, spraying from any direction at any force with any liquid is within the scope of the present invention.

In summary, the present invention combines specific components already in use in various products for similar and different uses. These are refrigerator, dishwasher, chemiclave (in the plumbed unit a reservoir to hold a several cups of white vinegar and it will dispense the appropriate amount necessary depending on the selection made), dental stone vibrator, clothes washing machine, fan and self-contained or plumbed coffee maker. As stated, the size of the unit may vary from the small portable countertop to that which may fit under most kitchen sinks for easy plumbing and storage or as a plumbed coffee maker be attractively designed similar to a dishwasher and be placed on the counter near the sink and outlet. There is a filter at the bottom of each chamber to collect larger particle to not clog the lines. The unit can appear in different model sizes:

The first is a single serving unit similar in size to a coffee maker which has two liquid decanters; one holds the cleansing liquid (fruit wash, vinegar and water), and the other holds water. The water can also be permanently attached or plumbed. The machine draws the cleansing liquid up into the spray jets and, depending the type of fruit or vegetable being cleaned, will spray with different forces. For example for cleaning strawberries verses grapes there will be a be a lighter force used coming from the jets for the strawberries. Then the water will spray through the same jets, but much more will be supplied to fill the compartment and soak the product. During the soak cycle, again depending on the type selected, the soak compartment can be agitated or vibrated. For example, one might soak and agitate mushrooms, but not raspberries. After the soak cycle is complete, the water drains and a fan can turn on to dry the cleansed food. In addition, the washing tray may be spun. This smaller unit can be self-contained or can be designed to hook up temporarily to any sink and drain into the sink

The second is a multi-serving and family cleaning unit that is similar to the smaller unit, but now the size and shape of a microwave or even a dishwasher for commercial units. The function is similar to the smaller unit being between that of a clothes washer and a dishwasher. This unit can be self-contained, hook up temporarily to any sink and drain into the sink or can be plumbed in permanently. Due to the unit's size permanent plumbing is preferred. This unit is able to clean larger items like cantaloupe or cucumber,

Both of the units can clean apples, plums, strawberries, green beans, broccoli, raspberries, blueberries, cherries, mushrooms, kiwi, potatoes and any other fruit or vegetable. The units can function as a refrigerator does in keeping the food and liquids used to clean at 40 degrees (before, during and after cleaning), (optimal temperature for fruits and vegetables). Foods may be cleaned in the morning for dinner use and left there because the present invention doubles as a refrigerator. There is no rush to move them until ready for use. It can be filled at any time with what you might use for several days to one week and have it washed and ready to consume at any given time. It is well-known that convenience is the most difficult part about eating healthy.

Several descriptions and illustrations have been provided to aid in understand the present invention. One with skill in the art will realize that numerous changes and variations may be made without departing from the spirit of the invention. Each of these changes and variations is within the scope of the present invention.

I claim:

1. A fruit and vegetable washer comprising:
a housing containing a compartment;
a controller mounted in said housing, the controller executing instructions of a program stored in a memory;
a spray head adapted to spray either a cleansing fluid or water into the compartment under control of the controller;
a fan under control of the controller adapted to dry fruit or vegetable products in the tray after washing is complete;
wherein, said instructions are adapted to first cause cleanser to be sprayed on the products in the compartment; then spray water over the products allowing the compartment to fill; then allow the products to soak; then drain the compartment and finally cause the fan to blow-dry the products.

2. The fruit and vegetable washer of claim 1 further comprising a spin unit wherein a tray containing said products can be spin-dried.

3. The fruit and vegetable washer of claim 2 wherein said spin unit may be adjusted to different spin speeds.

4. The fruit and vegetable washer of claim 1 further comprising a refrigerator unit adapted to keep the products at an optimum storage temperature.

5. The fruit and vegetable washer of claim 4 wherein the optimum storage temperature is between 40 and 50 degrees F.

6. The fruit and vegetable washer of claim 4 wherein said refrigerator unit is adjustable to different temperatures.

7. The fruit and vegetable washer of claim 1 wherein said controller is programmed to receive fruit and vegetable selections.

8. The fruit and vegetable washer of claim 7 wherein said controller executes instructions stored in the memory adapted to use different force sprays for different fruits or vegetables.

9. A fruit and vegetable washer comprising:
a housing containing a compartment;
a spray head adapted to spray either a cleansing fluid or water into the compartment;
a fan under control of the controller adapted to dry fruit or vegetable products in the tray after washing is complete;
a refrigerator unit adapted to keep the products at an optimum storage temperature.

10. The fruit and vegetable washer of claim 9 further comprising a spin unit wherein a tray containing said products can be spin-dried.

11. The fruit and vegetable washer of claim 10 wherein said spin unit is adjustable to different spin speeds.

12. The fruit and vegetable washer of claim 9 wherein said spray head is adjustable to spray with different forces.

13. The fruit and vegetable washer of claim 9 wherein the optimum storage temperature is between 40 and 50 degrees F.

14. The fruit and vegetable washer of claim 9 wherein said refrigerator unit is adjustable to different temperatures.

15. The fruit and vegetable washer of claim 9 further comprising a programmable controller adapted to execute instructions stored in a memory configured to control spay force, wash time, rinse time and drying time.

16. A method of supplying a fruit and vegetable washer comprising:
providing a housing containing a compartment;
providing a controller mounted in said housing, the controller executing instructions of a program stored in a memory;
providing a spray head adapted to spray either a cleansing fluid or water into the compartment under control of the controller;
providing a fan under control of the controller adapted to dry fruit or vegetable products in the tray after washing is complete; wherein, said instructions are adapted to first cause cleanser to be sprayed on the products in the compartment; then spray water over the products allowing the compartment to fill; then allow the products to soak; then drain the compartment and finally cause the fan to blow-dry the products.

17. The method of claim 16 further comprising providing a spin unit wherein a tray containing said products can be spin-dried.

18. The method of claim 17 of claim 2 wherein said spin unit may be adjusted to different spin speeds.

19. The method of claim 16 further comprising providing a refrigerator unit adapted to keep the products at an optimum storage temperature.
